(19) United States
(12) Patent Application Publication
(10) Pub. No.: US 2005/0271299 A1
(43) Pub. Date: Dec. 8, 2005

(54) Image transforming method, image transforming device and multiprojection system

(75) Inventors: Takeyuki Ajito, Hachioji City (JP); Kenro Ohsawa, Musashino City (JP); Takanori Ishizawa, Tachikawa City (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Corporation, Tokyo (JP)

(21) Appl. No.: 11/140,709

(22) Filed: May 31, 2005

(30) Foreign Application Priority Data
May 31, 2004 (JP) 2004-161726

(51) Int. Cl. G06K 9/76; G06K 9/40; G03B 21/26

(52) U.S. Cl. 382/293; 382/275; 353/30

(57) ABSTRACT

An image transforming device wherein one input image or a plurality of input images captured or created under different condition are geometrically transformed to create an output image, including: an input geometrical profile calculating section to calculate an input geometrical profile directing to a coordinate relation between pixel positions of the input image and polar coordinate positions of the input image in view of a given observing position; an output geometrical profile calculating section to calculate an output geometrical profile directing to a coordinate relation between pixel positions of the output image and polar coordinate positions of the output image in view of the observing position; and geometrical transforming section to geometrically transform the input image on the input geometrical profile and the output geometrical profile, thereby calculating the output image.

### BACKGROUND OF THE INVENTION

(i) Field of the Invention

The present invention relates to an image transforming method to conduct the geometrical modification of images to be input into the corresponding image projecting devices when wide viewing range content images such as dome images, arch images or panoramic images which are captured and created under any geometrical condition are projected and displayed on a screen of a predetermined shape with the image projecting devices, to an image transforming device to be used in the image transforming method and to a multiprojection system using the image transforming method.

(ii) Description of the Related Art

Recently, large-sized and high-definition type image displaying systems are widely available for showroom displays in museums and exhibitions, theater displays, planetarium displays or VR systems. In this case, in order to enhance realistic sensations, some systems to display wide viewing range images so as to cover the views of observers are developed and available.

If the wide viewing range image is projected and displayed with one image projecting device, the resolution and brightness of the image may be deteriorated because the projecting range is too wide in comparison with a conventional one. In this point of view, multiprojection systems are developed and available wherein high brightness and high resolution image displaying can be realized by combining images on a screen from the corresponding image projecting devices. In order to project and display the wide viewing range image without position shift and distortion using the multiprojection system, the arrangements and projection angles of the corresponding image projecting devices can be controlled in view of the position and shape of the screen so that the images (content images) of the corresponding image projecting devices are geometrically corrected appropriately and then, input into the corresponding image projecting devices.

It is known as the image correcting method that the content images to be input into the corresponding image projecting devices are geometrically corrected on the arrangement and the projecting directions of the image projecting devices so that the position shifts and distortions of the dome images are corrected (see, Patent Publication No. 1).

In contrast, it is also known that a wide viewing range image such as a panoramic image or an dome image is captured several times to create a polar coordinate image covering the view angle over 360 degrees as the content images (see, Patent Publications No. 2 and 3).

[Patent Publication No. 1]

Japanese Patent Publication Laid-open No. 2000-152131
   [Patent Publication No. 2]
Japanese Patent Publication Laid-open No. 9-62861
   [Patent Publication No. 3]
Japanese Patent Publication Laid-open No. 2003-141562

### SUMMARY OF THE INVENTION

(iii) Problems to be Solved by the Present Invention

With the image correcting method disclosed in Patent publication No. 1, however, it is required that a content image within a predetermined projection range is prepared before geometrical transformation per the corresponding image projecting device. In this point of view, if the arrangement and the number of the image projecting devices may be varied, the content image must be recreated and prepared again per the corresponding projection device, which are troublesome tasks. If the content image can be displayed by three-dimensional CG data technique, the content image can be recreated by changing the rendering. In this case, too, however, if a practically captured content image is intended as the content image, the content image must be captured again, which make the image correcting method difficult.

In contrast, if such a polar coordinate image is employed as the content image as disclosed in Patent Publications No. 2 and 3, since the polar coordinate image can be cut out commensurate with the arrangement of the image projecting devices, the users can cope with the variation in the arrangement and the number of the image projecting devices.

In this case, however, if such an attempt is made as to create the polar coordinate image without data deterioration for a captured image, the size of the polar coordinate image may be enlarged extremely. Since the polar coordinate system to be employed is not normal, it is difficult to edit and process the content image using the polar coordinate system. In this point of view, since various polar coordinate systems have been research and developed, none of the polar coordinate systems can iron out the above-mentioned problems.

Patent Publication No. 2 discloses that if the information relating to capturing directions and angles are added and served for the images which are obtained by capturing a panoramic image covering 360 degrees views several times, the captured image can be geometrically transformed directly into the corresponding displaying image on view angle even though the polar coordinate image is not created. In this case, therefore, the intended content image can be edit and processed on the captured image of the orthogonal coordinates without image deterioration.

However, the image transforming method disclosed in Patent Publication No. 2 is specialized for a displaying system relating to a panoramic image, so can not cope with a displaying system to be employed under any capturing condition and any displaying condition. Therefore, for example, if a dome-shaped curved screen or an arch-shaped curve screen are employed as the displaying means or if a content image which is captured over all of the view angles such as a dome image instead of the panoramic image of one-dimensional capturing angle, the intended wide viewing range image can not be created only in view of the capturing directions and angles as mentioned above.

In view of the above-mentioned problems, it is an object of the present invention to provide an image transforming method wherein a wide viewing range content image which is captured and/or created under a given geometrical condition is geometrically corrected by an always similar geometrical transforming process to provide a wide viewing range image without projection image shift and distortion, to provide an image transforming device to be used in the image transforming method and to a multiprojection system using the image transforming device.

In order to achieve the above object, the invention of claim 1 relates to an image transforming method comprising the steps of:
obtaining one input image or a plurality of input images captured or created under different condition, and
geometrically transforming the one input image or the plurality of input images to create an output image,
wherein the geometrical transformation is carried out on an input geometrical profile directing to a coordinate relation between pixel positions of the input image and polar coordinate positions of the input image in view of a given observing position and an output geometrical profile directing to a coordinate relation between pixel positions of the output image and polar coordinate positions of the output image in view of the observing position, thereby calculating the output image.

The invention of claim 2 relates to an image transforming method as defined in claim 1,
wherein the input geometrical profile includes at least one selected from the group consisting of a two-dimensional look-up table to define a coordinate relation per pixel of the input image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein the output geometrical profile includes at least one selected from the group consisting of a two-dimensional look-up table to define a coordinate relation per pixel of the output image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein the geometrical transformation is carried out on at least one selected from a coordinate transformation using a table transformation with the two-dimensional look-up table, a projecting transformation using the projective transformation, a polar coordinate transformation using the polar coordinate transforming coefficient, a cylindrical transformation using the cylindrical coordinate transforming coefficient and a polynomial coordinate transformation using the polynomial transforming coefficient of the input geometrical profile and the output geometrical profile, thereby calculating the output image.

The invention of claim 3 or 4 relates to an image transforming method as defined in claim 1 or 2, further comprising the step of calculating an input-output geometrical profile directing to a coordinate relation between a coordinate position of the input image and a coordinate position of the output image from the input geometrical profile and the output geometrical profile,
wherein the geometrical transformation is carried out on the input-output geometrical profile, thereby calculating the output image.

The invention of any one of claims 5˜8 relates to an image transforming method as defined in the corresponding one of claims 1˜4, further comprising the steps of:
obtaining coordinate positions of the input image corresponding to coordinate positions for pixels of the output image at calculated boundary of the output image on the input geometrical profile and the output geometrical profile, and
cutting images from the input image on the coordinate positions of the input image to create cutting images,
wherein the geometrical transformation is carried out for the cutting images, thereby calculating the output image.

The invention of claim 6 relates to an image transforming device wherein one input image or a plurality of input images captured or created under different condition are geometrically transformed to create an output image, comprising:
an input geometrical profile calculating section to calculate an input geometrical profile directing to a coordinate relation between pixel positions of the input image and polar coordinate positions of the input image in view of a given observing position,
an output geometrical profile calculating section to calculate an output geometrical profile directing to a coordinate relation between pixel positions of the output image and polar coordinate positions of the output image in view of the observing position, and
geometrical transforming section to geometrically transform the input image on the input geometrical profile and the output geometrical profile, thereby calculating the output image.

The invention of claim 10 relates to an image transforming device as defined in claim 9, wherein the output geometrical profile calculates a plurality of output geometrically profiles for corresponding image output devices, and the geometrical transforming device calculates output images for the geometrical profiles, respectively.

The invention of claim 11 or 12 relates to an image transforming device as defined in claim 9 or 10, wherein the input geometrical profile calculating section calculates an input geometrical profile including at least one selected from the group consisting of a two-dimensional look-up table to define a coordinate relation per pixel of the input image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein the output geometrical profile calculating section calculates an output geometrical profile including at least one selected from the group consisting of a two-dimensional look-up table to define a coordinate relation per pixel of the output image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein the geometrical transforming section includes at least one selected from a coordinate transformation using a table transformation with the two-dimensional look-up table, a projecting transformation using the projective transformation, a polar coordinate transformation using the polar coordinate transforming coefficient, a cylindrical transformation using the cylindrical coordinate transforming coefficient and a polynomial coordinate transformation using the polynomial transforming coefficient of the input geometrical profile and the output geometrical profile.

The invention of any one of claims 13-16 relates to an image transforming device as defined in the corresponding one of claims 9˜12, further comprising an input-output geometrical profile calculating section to calculate an input-output geometrical profile to define a coordinate relation between a coordinate position of the input image and a coordinate position of the output image on the input geometrical profile and the output geometrical profile,
wherein the input image is geometrically transformed on the input-output geometrical profile, thereby calculating the output image.

The invention of any one of claims 17˜24 relates to an image transforming device as defined in the corresponding one of claims 9˜16, further comprising an image cutting means to obtain coordinate positions of the input image corresponding to coordinate positions for pixels of the output image at calculated boundary of the output image on the input geometrical profile and the output geometrical profile and to cut images from the input image on the coordinate positions of the input image to create cutting images,
wherein the cutting images are geometrically transformed, thereby calculating the output image.

The multiprojection system of claim 25 relates to a multiprojection system wherein one input image or a plurality of input images captured or created under different condition are geometrically transformed by an image transforming device to create a plurality of output images which are projected on a screen by corresponding image projecting devices and combined with one another to create a large-sized image,
wherein the image transforming device comprises:
an input geometrical profile calculating section to calculate an input geometrical profile directing to a coordinate relation between pixel positions of the input image and polar coordinate positions of the input image in view of a given observing position,
an output geometrical profile calculating section to calculate an output geometrical profile directing to a coordinate relation between pixel positions of the output image and polar coordinate positions of the output image in view of the observing position, and
geometrical transforming section to geometrically transform the input image on the input geometrical profile and the output geometrical profile, thereby calculating the output image.

The invention of claim 26 relates to a multiprojection system as defined in claim 25, wherein the input geometrical profile calculating section calculates an input geometrical profile including at least one selected from the group consisting of a two-dimensional look-up table to define a coordinate relation per pixel of the input image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein the output geometrical profile calculating section calculates an output geometrical profile including at least one selected from the group consisting of a two-dimensional look-up table to define a coordinate relation per pixel of the output image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein the geometrical transforming section includes at least one selected from a coordinate transformation using a table transformation with the two-dimensional look-up table, a projecting transformation using the projective transformation, a polar coordinate transformation using the polar coordinate transforming coefficient, a cylindrical transformation using the cylindrical coordinate transforming coefficient and a polynomial coordinate transformation using the polynomial transforming coefficient of the input geometrical profile and the output geometrical profile.

The invention of claim 27 or 28 relates to a multiprojection system as defined in claim 25 or 26, further comprising an input-output geometrical profile calculating section to calculate an input-output geometrical profile to define a coordinate relation between a coordinate position of the input image and a coordinate position of the output image on the input geometrical profile and the output geometrical profile,
wherein the input image is geometrically transformed on the input-output geometrical profile, thereby calculating the output image.

The invention of any one of claims 29˜32 relates to a multiprojection system as defined in the corresponding one of claims 25˜28, further comprising an image cutting means to obtain coordinate positions of the input image corresponding to coordinate positions for pixels of the output image at calculated boundary of the output image on the input geometrical profile and the output geometrical profile and to cut images from the input image on the coordinate positions of the input image to create cutting images,
wherein the cutting images are geometrically transformed, thereby calculating the output image.

The invention of any one of claims 33˜40 relates to a multiprojection system as defined in the corresponding one of claims 25˜32, further comprising:
a test pattern image outputting means to provide test pattern images for the image projecting devices, and
a calibration image acquiring means to capture test pattern projecting images on the screen by the image projecting devices,
wherein the output geometrical profile calculating section calculates an output geometrical profile directing at a coordinate relation between coordinate positions of the test pattern projecting images acquired by the calibration image acquiring means and the polar coordinate positions of the output image in view of the observing position.

The invention of any one of claims 41˜56 relates to a multiprojection system as defined in the corresponding one of claims 25˜40, further comprising a geometrical profile combining means to combine and output or store the input image and the input geometrical profile or to combine and output or store an output image transformed by the image transforming device and the output geometrical profile.

According to the present invention, since the coordinate relation between the coordinate positions of an input mage and an output image and the corresponding polar coordinate positions in view of observing position is calculated as a geometrical profile, on which the input image is geometrically transformed into the output image, an content image captured or created under a given condition can be displayed in wide viewing range by any displaying system without position shift and distortion in view of the observing position. Moreover, since the content image can be edit and processed on a coordinate system which can simplify the editing and processing for the content image irrespective of the conditions at capturing and displaying, the content image can be easily handled so that the content image can be easily delivered, distributed and stored.

### BRIEF DESCRIPTION OF THE DRAWINGS

In order to bring about a greater understanding of the present invention, a description will be given on the accompanying drawings.

FIG. 1 is a structural view schematically showing a multiprojection system entirely according to a first embodiment of the present invention,

FIG. 2 is a concrete explanatory views relating to input geometrical information and output geometrical information in the image transforming section in FIG. 1,

FIG. 3 is a structural view concretely showing an input geometrical profile which is to be formed on the input geometrical information,

FIG. 4 is a structural view concretely showing an output geometrical profile which is to be formed on the output geometrical information,

FIG. 5 is a structural view concretely showing the coordinate transforming table in FIGS. 3 and 4,

FIG. 6 is an explanatory views showing the coordinate relation between the orthogonal coordinate and the polar coordinate of an input image to be described in the input geometrical profile,

FIG. 7 is an explanatory views showing the coordinate relation between the orthogonal coordinate and the polar coordinate of an output image to be described in the output geometrical profile,

FIG. 8 is a block diagram showing the structure of the geometrical transforming section in FIG. 1,

FIG. 9 is an explanatory view of the polar coordinate table of the input and output geometrical profiles which are formed in the input and output geometrical profile calculating sections,

FIG. 10 is a flowchart relating to the geometrical transformation using the input and output geometrical profiles,

FIG. 11 is another flowchart relating to the geometrical transformation using the input and output geometrical profiles,

FIG. 12 is a structural view showing an essential part of a multiprojection system according to a second embodiment of the present invention,

FIG. 13 is a structural view showing the multiprojection system using the image transformation relating to the second embodiment,

FIG. 14 is another structural view showing the multiprojection system using the image transformation relating to the second embodiment,

FIG. 15 is a structural view showing an essential part of a multiprojection system according to a third embodiment of the present invention,

FIG. 16 is a structural view showing an essential part of a multiprojection system according to a fourth embodiment of the present invention,

FIG. 17 is a flowchart in the image cutting section of FIG. 16,

FIG. 18 is a structural view showing an essential part of a multiprojection system according to a fifth embodiment of the present invention,

FIG. 19 is a structural view showing an essential part of a multiprojection system according to a sixth embodiment of the present invention, and

FIG. 20 is a structural view showing an essential part of a multiprojection system according to a seventh embodiment of the present invention.

### DETAILED DESCRIPTION OF THE PREFERRED EMBODIMENTS

The present invention will now be described hereinafter with reference to the accompanying drawings.

### First Embodiment

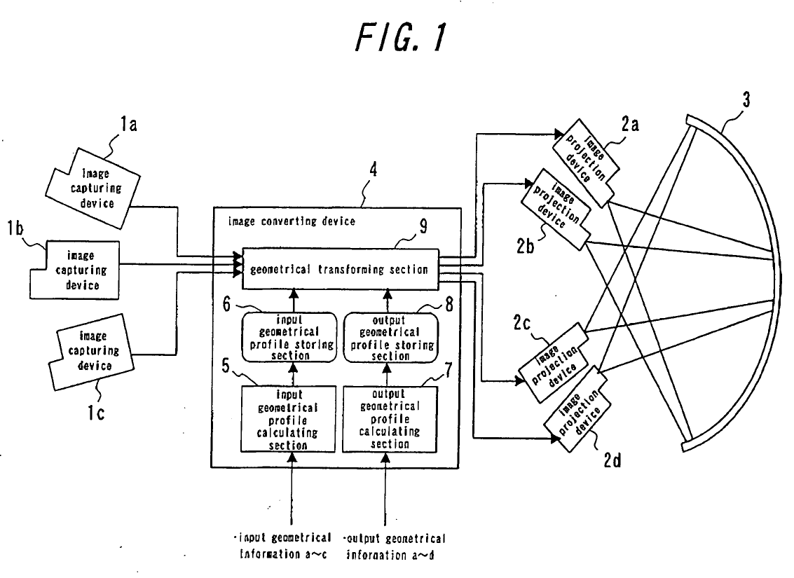

FIGS. 1-13 relate to a multiprojection system according to a first embodiment of the present invention. The multiprojection system, as the entire structure is shown in FIG. 1, includes a plurality of (in this embodiment, three) image capturing devices 1a˜1c, a plurality of (in this embodiment, four) image projection systems 2a˜2d as image output systems, a screen 3 and an image transforming device 4 to transform image data input from the image capturing devices 1a˜1c and to output into the image projecting devices 2a˜2d.

The image capturing devices 1a˜1c includes CCDs, CMOSs, etc., respectively, thereby to be constituted as moving image cameras such as digital cameras or HDTV cameras which acquire monochrome images or multiband color images as digital data. In order to acquire a wide range image, the image capturing devices 1a˜1c may include fish-eye lens.

The image projecting devices 2a˜2d may include, as spatial light modulators, transmitting liquid crystal elements, reflective liquid crystal elements, projectors with digital micromirror devices, CRT projection tube displays or laser scan displays, etc.

The screen 3 may be constituted from a transmitting screen or a reflective screen made of a diffusion plate, a lenticular or a Fresnel mirror. The shape of the screen 3 may be set plane shape, arch shape, dome shape, panoramic shape or box shape.

The image transforming device 4 is configured such that input geometrical information a˜c and output geometrical information a˜d are input which relates to geometrical conditions of the image capturing devices 1a˜1c and image projecting devices 2a˜2d. Then, the image transforming device 4 includes an input geometrical profile calculating section 5 to calculate an input geometrical profile relating to the coordinate relation between the ordinate system of the images input from the image capturing devices 1a˜1c on the input geometrical information a˜c and the polar coordinate system in view of observing position, an input geometrical profile storing section 6 to store the input geometrical information, an output geometrical profile calculating section 7 to calculate an output geometrical profile to define the coordinate relation between the coordinate system of the images to be input into the image projecting devices 2a˜2d corresponding to the output geometrical information a˜d, an output geometrical profile storing section 8 to store the output geometrical profile calculated and a geometrical transforming section 9 to geometrically transform the images input from the image capturing devices 1a˜1c on the input geometrical profile and output geometrical profile which are stored in the input geometrical profile storing section 6 and the output geometrical profile storing section 8. If the images geometrically transformed by the image transforming device 4 are input into the image projecting devices 2a˜2d, a wide viewing range image can be displayed without position shift and distortion.

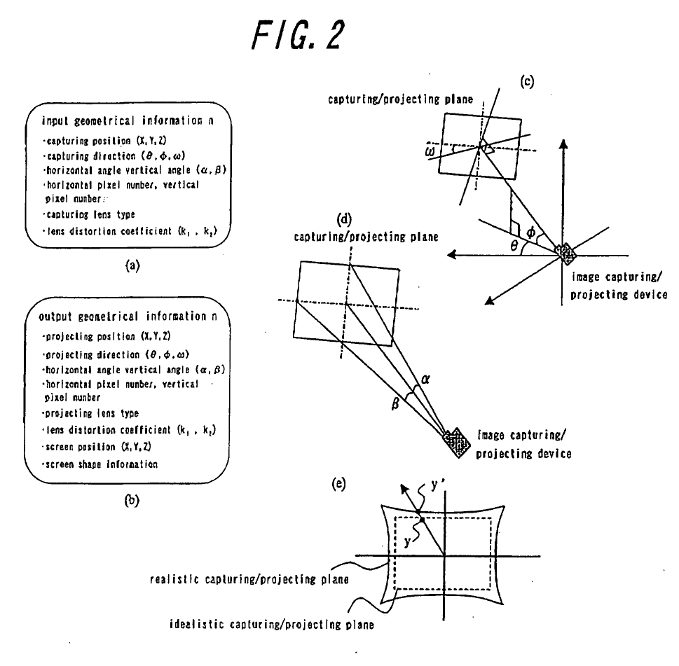

FIG. 2 is an explanatory view showing concrete input geometrical information a˜c which are to be input into the image transforming device 4 and output geometrical information a˜d. As is apparent from FIG. 2(a), the input geometrical information a˜c include the three-dimensional positions (X, Y, Z) and the capturing directions (θ, φ, ω) of the corresponding image capturing devices at capturing, and the horizontal and vertical angles (α, β), the horizontal and vertical pixel number, the imaging principle such as f-tan θ or f-θ and the lens distortion coefficients (k1, k2) due to lens astigmatismus of the capturing lens. As is apparent from FIG. 2(b), the output geometrical information a˜d include the three-dimensional positions (X, Y, Z) and the capturing directions (θ, φ, ω) of the corresponding image projecting devices at image projection at the standard observing position, and the horizontal and vertical angles (α, β), the horizontal and vertical pixel number and the lens distortion coefficients (k1, k2) due to lens astigmatismus of the capturing lens. The output geometrical information also include the three-dimensional positions (X, Y, Z) as the observing position of the screen 3 is defined as standard and the screen shape information such as the curvature of the screen 3, etc.

As is apparent from FIG. 2(c), the capturing direction and the projection direction (θ, φ, ω) correspond to the three-dimensional capturing angle and projection angle of the capturing/projecting plane of the corresponding image capturing/projecting device. As is apparent from FIG. 2(d), the horizontal and vertical angles (α, β) define the horizontal and vertical image capturing/projection range of the capturing/projection plane of the corresponding image capturing/projecting device.

Then, as is apparent from FIG. 2(e), the lens distortion coefficient (k1, k2) can be represented by the following equation (1) which means the difference between the image focus location “y” of the idealistic capturing/projection plane without lens astigmatismus and the image focus location “y′” of the realistic capturing/projection plane.
y′−y=Δy=k1·y³+k2·y⁵ (1)

If the above-described geometrical information are employed, the coordinate relation between the coordinate system of the content images captured at the image capturing devices 1a˜1c and the output images from the image projecting devices 2a˜2d and the polar coordinate system in view of the standard observing position can be calculated.

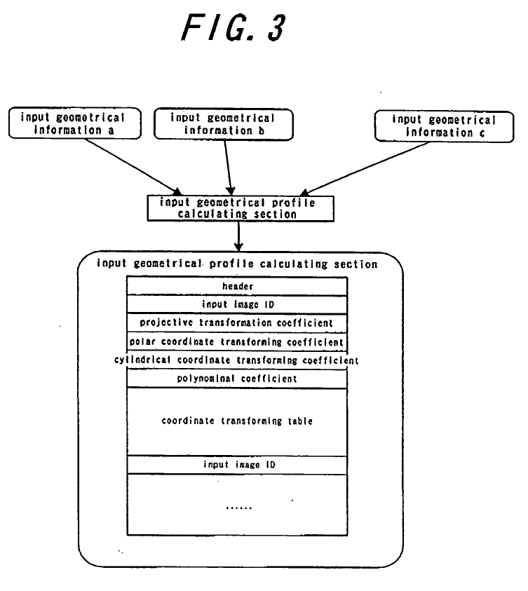

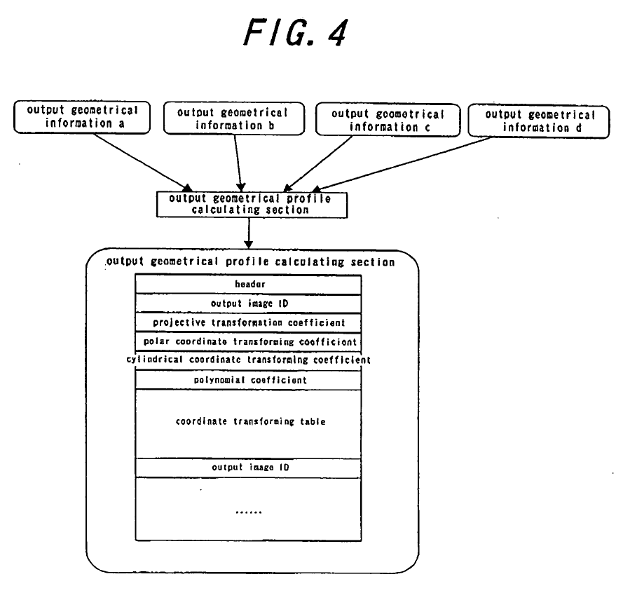

FIGS. 3 and 4 shows the input geometrical profile and the output geometrical profile in detail which are calculated at the input geometrical profile calculating section 5 and the output geometrical profile calculating section 7 which are shown in FIG. 2 and are stored in the input geometrical profile storing section 6 and the output geometrical profile storing section 7. As shown in FIGS. 3 and 4, the input geometrical profile and the output geometrical profile includes headers, input image IDs (or output image IDs in the output geometrical profile), projective transformations, polar coordinate transforming coefficients, cylindrical coordinate transforming coefficients, polynominal transforming coefficients and coordinate transforming table (two-dimensional look-up table), respectively.

Herein, into the header are described the number of the input images captured several times (or the number of the output images in the output geometrical profile) and which transformation of coordinate transforming equations should be utilized. The input image ID of the input geometrical profile is an identification number of input image, and the output image ID of the output geometrical profile is an identification number of output image. The transforming coefficients below the input image ID (or the output image ID in the output geometrical profile) can be defined as the coefficients of the following coordinate transforming equations (2)-(5);
Projection Transforming Equation:

$$u = \frac{ax + by + c}{x + dy + e} , v = \frac{fx + gy + h}{x + iy + j} \qquad ( 2 )$$

Polar Coordinate Transforming Equation:
u=a·arctan(bx+c)+d, v=e·arctan(fy+g)+h (3)
Cylindrical Coordinate Transforming Equation:
u=a·arctan(bx+c)+d, v=e·cos(fy+g)+h (4)
Polynomial Transforming Equation:

$$u = \frac{{\sum }_{m = 0}^{M} ( {a}_{m} {x}^{m} + {b}_{m} {y}^{m} )}{α x + β y + 1} , v = \frac{{\sum }_{m = 0}^{M} ( {c}_{m} {x}^{m} + {d}_{m} {y}^{m} )}{α x + β y + 1} \qquad ( 5 )$$

Herein, in the above equations, the coefficients a, b, c, d, e, f, g, h, i, j, aₘ, bₘ, cₘ′, dₘ (m=0˜M: M is a polynomial order) α, β are transforming coefficients, the (x, y) and the (u, v) means coordinates after and before transformation.

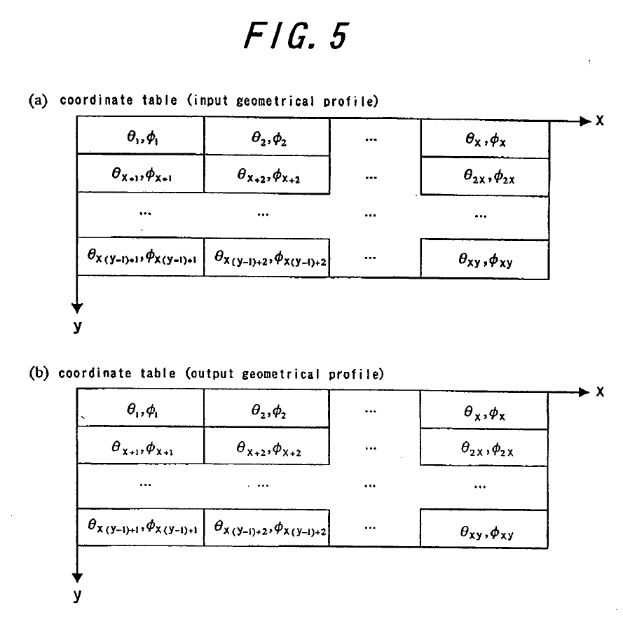

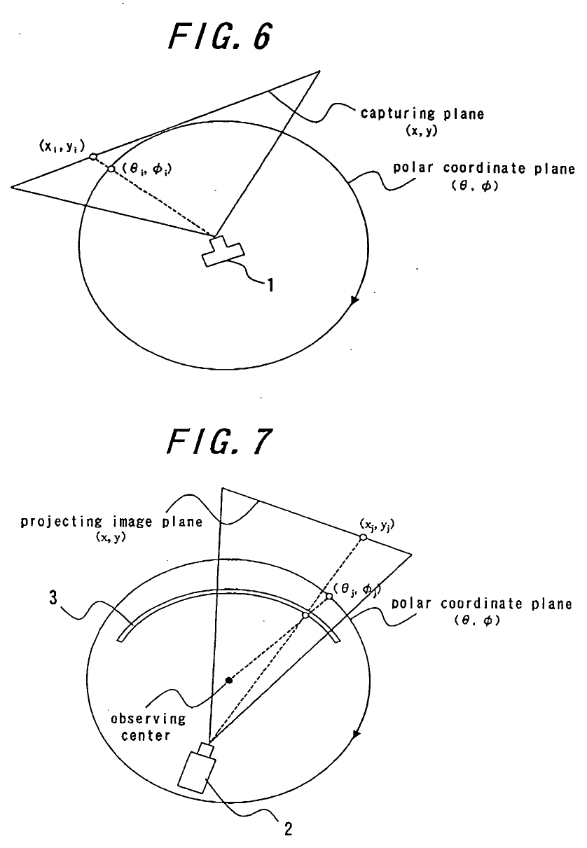

As shown in FIGS. 5(a) and 5(b), in the coordinate transforming tables, the polar coordinate positions corresponding to the pixels of the input image and the output image are described as table data. As shown in FIG. 6, in the input geometrical profile, the coordinate position (θi, θi) on the polar coordinate system in view of the standard observing position for pixels (xi, yi) of the captured image of the imaging plane (x, y) is described. In this embodiment relating to FIG. 6, the observing position and the capturing position by the image capturing device 1 coincide with one another. As shown in FIG. 7, in the output geometrical profile, the points to be projected on the screen 3 are determined (described) for pixels (xi, yi) of an output image on the image plane (x, y) by the image projecting device 2, and the polar coordinate positions (θi, θi) as the standard observing positions are described commensurate with the projected points on the screen 3.

If in the geometrical transforming section 9, the coordinate transformation is performed by utilizing the input geometrical profile and the output geometrical profile as described above, the input image and the output image can be transformed from on the orthogonal coordinate system into on the polar coordinate system or another coordinate system.

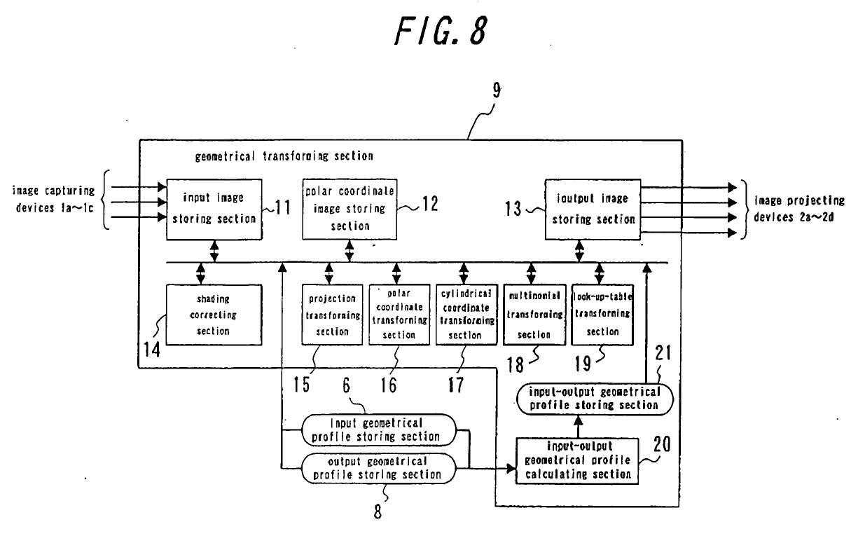

FIG. 8 is a block diagram showing the structure of the geometrical transforming section 9. The geometrical transforming section 9 includes an input image storing section 11, a polar coordinate image storing section 12, an output image storing section 13, a shading correcting section 14, a projection transforming section 15, a polar coordinate transforming section 16, a cylindrical coordinate transforming section 17, a polynomial transforming section 18, a look-up-table transforming section 19, an input-output profile calculating section 20 and an input-output geometrical profile storing section 21.

The input image storing section 11 stores the image data from the image capturing devices 1a˜1c. Also, the polar coordinate storing section 12 stores the image data which are stored in the input image storing section 11 and transformed from on the orthogonal coordinate system into on the polar coordinate system on the input geometrical profile at at least one selected from the group consisting of the projection transforming section 15, the polar coordinate transforming section 16, the cylindrical coordinate transforming section 17, the polynomial transforming section 18 and the look-up-table transforming section 19. The output image storing section 13 stores the image data which is stored in the polar coordinate image storing section 12 and transformed from on the polar coordinate system into the orthogonal coordinate system at at least one selected from the group consisting of the projection transforming section 15, the polar coordinate transforming section 16, the cylindrical coordinate transforming section 17, the polynomial transforming section 18 and the look-up-table transforming section 19. The image data stored in the output image storing section 13 is output into the image projecting devices 2a˜2d.

The shading correcting section 14 corrects in image brightness the input images on the polar coordinate system so that the images can be combined with one another smoothly by carrying out the brightness shading for the boundary areas/overlapping areas of the images. The shading correcting section 14 can carry out the brightness shading for the boundary areas/overlapping areas of the output images.

The projection transforming section 15, the polar coordinate transforming section 16, the cylindrical coordinate transforming section 17, the polynomial transforming section 18 and the look-up-table transforming section 19 can transform the input images into the images on the polar coordinate system and the images on the polar coordinate system into the output images by carrying out the coordinate transformation on the transforming equations (2)-(5) and the table (refer to FIG. 5) on the transforming coefficients described in the input geometrical profile and the output geometrical profile and on the data stored in the coordinate transforming table.

Herein, in this embodiment, the input image may be transformed directly into the output image through the coordinate transformation not by utilizing the polar coordinate image storing section 12. In this point of view, the input-output geometrical profile calculating section 20 and the input-output geometrical profile storing section 21 are provided. In the input-output profile calculating section 20 is calculated the input-output geometrical profile directing at the coordinate relation between the coordinate system of the input image and the polar coordinate system of the output image by utilizing the input geometrical profile and the output geometrical profile, which the input-output profile is stored in the input-output geometrical profile storing section 21.

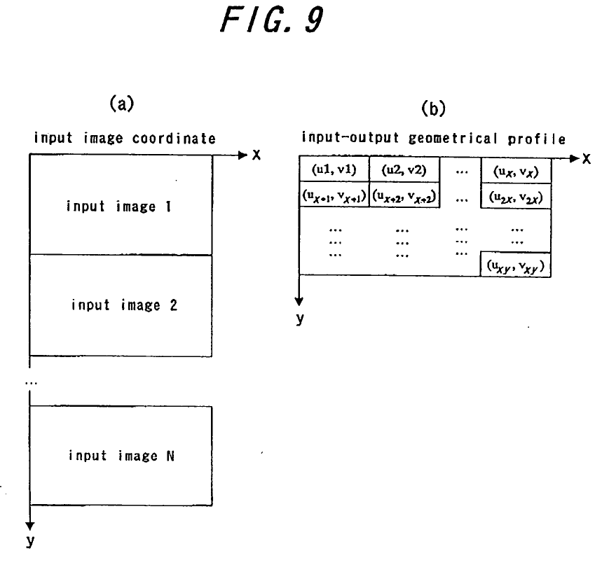

Herein, the input-output geometrical profile can have the same structure as the output geometrical profile shown in FIG. 4. Into the input-output geometrical profile are described the transforming coefficients relating to the transformation of the coordinate positions of the input images corresponding to the coordinate positions of the pixels of the output images. The transforming coefficients are calculated on the input geometrical profile and the output geometrical profile. As shown in FIG. 9(a), the table data wherein the coordinate positions of the input images corresponding to the pixels of the output image are stored per pixel can be described. As shown in FIG. 9(b), the coordinate positions for one large image made of a plurality of images which are arranged in the y-direction can be described.

In this way, if the input-output geometrical profile is calculated at the input-output geometrical profile calculating section 20 and stored in the input-output geometrical storing section 21, the input image can be directly transformed into the corresponding output image without the polar coordinate system by using the input-output geometrical profile, resulting in the mitigation in calculation relating to the transformation between the input image and the output image.

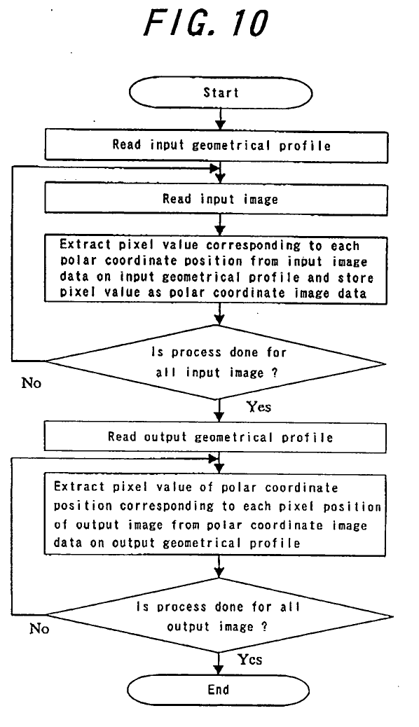

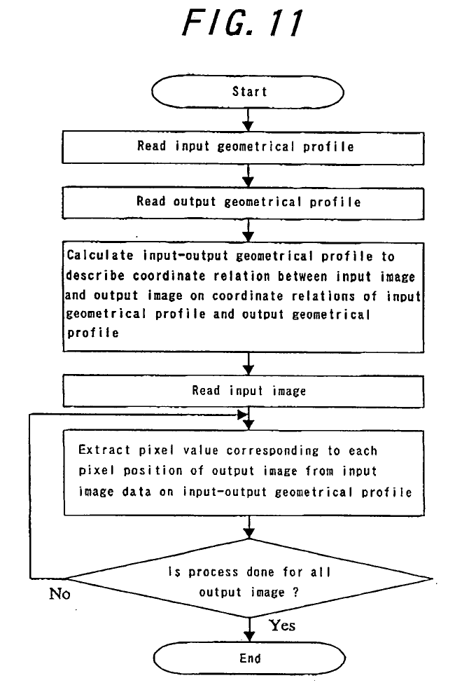

FIGS. 10 and 11 relate to flowcharts at the geometrical transforming section 9. FIG. 10 relates to a flowchart wherein the polar coordinate image is created on the input geometrical profile, and then, the output image is created on the output geometrical profile. FIG. 11 relates to a flowchart wherein the input-output geometrical profile is calculated to directly transform the input image into the output image. For convenience, detail explanations will be omitted because they are overlapped with one another.

In this way, if the geometrical profiles are calculated on the geometrical information relating to the input images and the output images, and the geometrical transformation is carried out on the geometrical profiles, the content images which are created on a capturing method or a creating method under a given geometrical condition can be displayed as a wide viewing range image without distortion and position shift by using a displaying system under a given projecting principle.

### Second Embodiment

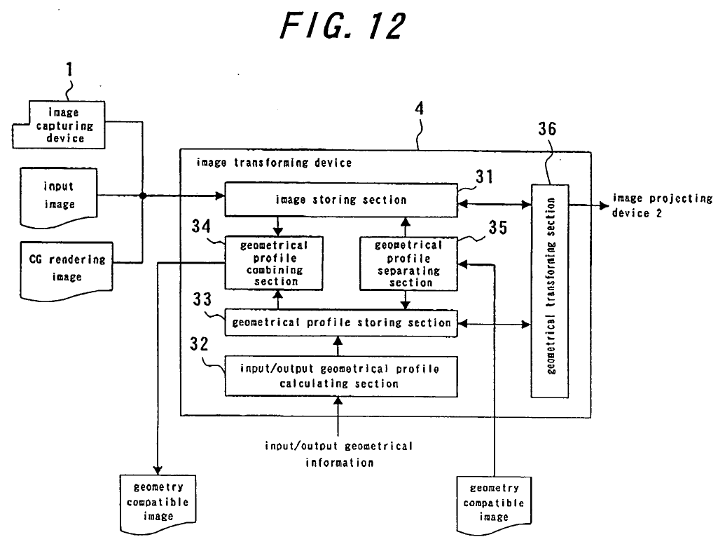

FIGS. 12-14 relate to a multiprojection system according to a second embodiment of the present invention.

In this embodiment, as shown in FIG. 12, the image transforming device 4 includes an image storing section 31, an input/output geometrical profile calculating section 32, a geometrical profile storing section 33, a geometrical profile combining section 34, a geometrical profile separating section 35 and a geometrical transforming section 36.

Various input images are stored into the image storing section 31. As the input images can be exemplified an image captured at the image capturing device 1, an image stored once in a file after the capturing at the image capturing device 1, and an image rendering from the observing position and the observing direction of a three-dimensional CG data. The input/output geometrical profile calculating section 32 can be configured such that the section 32 can have the same functions as the input geometrical profile calculating section 5 and the output geometrical profile calculating section 7 in the first embodiment, so that the input/output geometrical profile calculating section 32 calculates, on an external input geometrical information, an input geometrical profile directing at the coordinate relation between the coordinate system of an input image and the polar coordinate system as the standard observing position, and on external output geometrical information, an output geometrical profile directing at the coordinate relation between the coordinate system of an image to be input into the image projecting device 2 and the polar coordinate system. The input geometrical profile and the output geometrical profile are stored in the geometrical profile storing section 33.

The geometrical profile combining section 34 combines the input geometrical profile calculated with the corresponding input image to create an image with a geometrical profile (which is called as a “geometry compatible image”). The geometrical profile separating section 35 separates the input geometrical profile and the input image on the geometry compatible image which is read in the section 35. The geometrical transforming section 36 can have the same function as the geometrical transforming section 9 in the first embodiment.

In this embodiment, since the input image and the input geometrical profile are combined at the image transforming device 4 to create and output the geometry compatible image, the geometrically variable image can be stored. Also, in the image transforming device 4, the input geometrical profile and the input image of the geometry compatible image read therein are separated, and the input image is geometrically transformed on the input geometrical profile, the input image and the output geometrical profile read therein, and output into the image projecting device 2. Moreover, the output image transformed at the geometrical transforming section 36 is combined with the output geometrical profile used in the transformation and stored as the geometry compatible image.

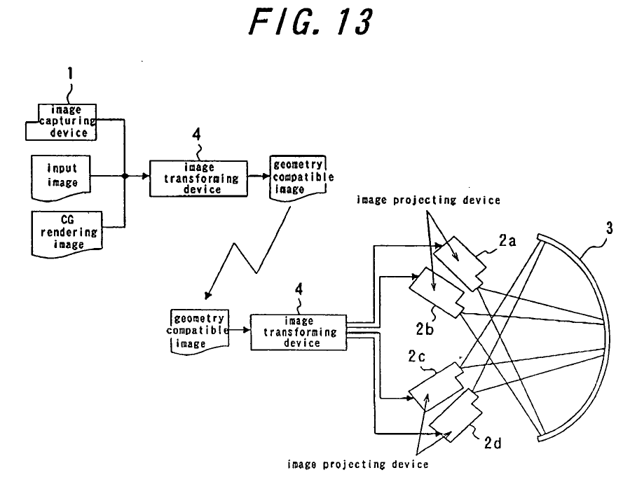

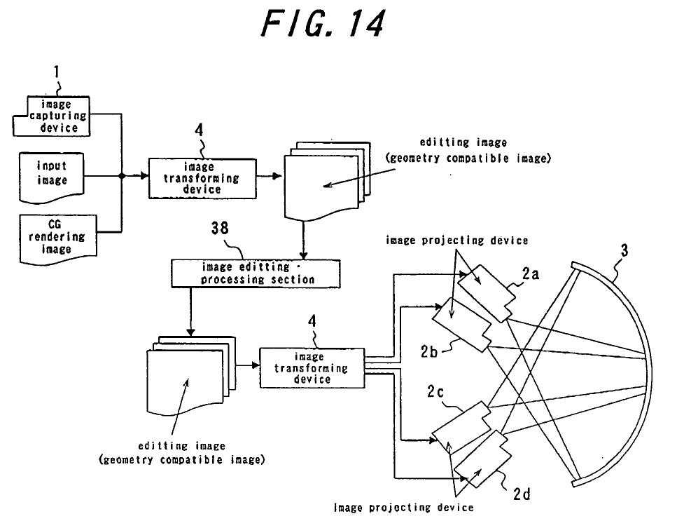

In this embodiment, in this way, at the image transforming device 4, the geometry compatible image can be created and the intended geometrical transformation can be carried out on the geometrically variable image read in the device 4. For example, as shown in FIG. 13, therefore, even though the content creating section is away from the content displaying section, if a given geometry compatible image is created under a given geometrical condition at the image transforming device 4 in the creating section, transferred to the displaying section via a recording medium, a LAN or a global network, and geometrically transformed to create the output image which is later input in the image projecting devices 2a˜2d and displayed on the screen 3, an intended wide viewing range image can be displayed on the screen 3 irrespective of the geometrical condition at capturing or creating in the creating section.

In this embodiment, since the image transforming device 4 can output an image as a geometry compatible image after geometrical transformation at the geometrical transforming section 36, for example, as shown in FIG. 14, if a wide viewing range image is displayed through edit and process, an input image is geometrically transformed into a geometry compatible image to be output on a coordinate system for the edit and process, and the geometry compatible image is processed and edit at the image editing and processing section 38 and displayed at the image transforming device 4 in the displaying section through the geometrical transformation on the geometrical profile at the edit and process.

In this way, the content images can be edit, processed or recognized on the coordinate system which can simplify the process and the edit, and the intended image can be captured, created or displayed irrespective of the selected coordinate system (the coordinate system to be selected) in the creating section and the displaying section.

### Third Embodiment

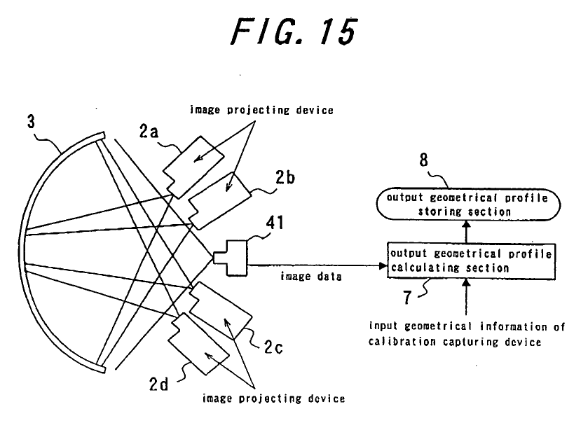

FIG. 15 is a structural view showing an essential part of a multiprojection system according to a third embodiment of the present invention. In this embodiment, in the calculating of an output geometrical profile, test pattern images are projected on the screen 3 from the image projecting devices 2a˜2d and captured by a calibration capturing device 41 so that output geometrical profiles directing at the coordinate relations between the coordinate systems of output images at the image projecting devices 2a˜2d and the corresponding polar coordinate systems.

The output geometrical profile is calculated at the output geometrical profile calculating section 7 and stored in the output geometrical profile storing section 8. In this case, the input geometrical information of the calibration capturing device 41 relating to the coordinate relation between the coordinate system of the image captured by the calibration capturing device 41 and the corresponding polar coordinate system is utilized. Therefore, the output geometrical profile directing at the coordinate system of the output image (=the coordinate system of the test pattern) and the corresponding polar coordinate system can be obtained from the test pattern image captured by the calibration capturing device 41.

In this way, since the output geometrical profiles corresponding to the image projecting devices 2a˜2d can be calculated by utilizing the captured image by the calibration capturing device 41, the output geometrical profiles can be calculated easily even though the concrete arrangement of the image projecting devices 2a˜2d and the concrete shape of the screen 3 are unknown. Even though the arrangement and/or the projecting positions of the image projecting devices 2a˜2d, the output geometrical profile can be modified easily by the calibration capturing device 41.

### Fourth Embodiment

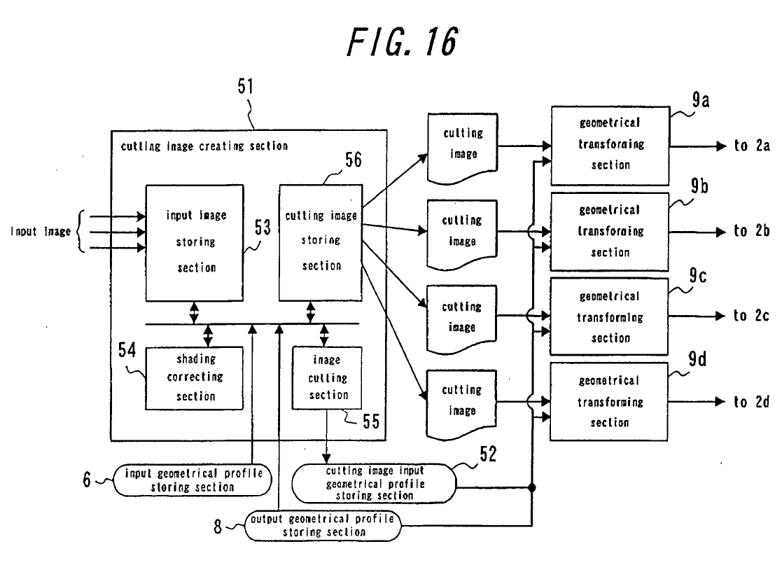

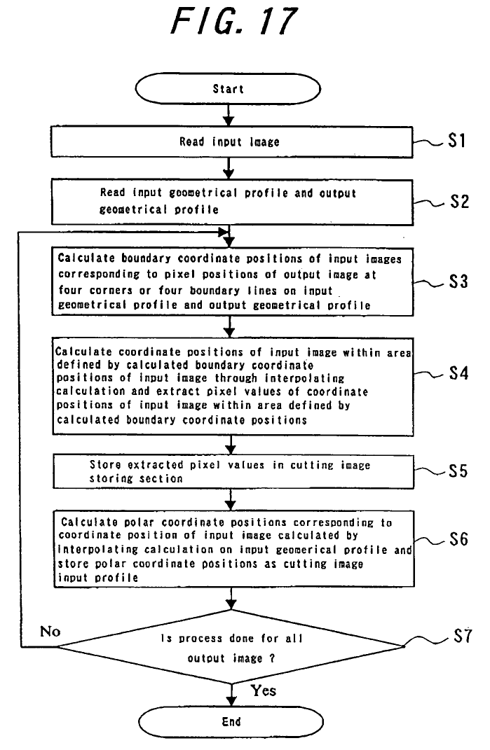

FIGS. 16 and 17 relates to a multiprojection system according to a fourth embodiment of the present invention. In this embodiment, as shown in FIG. 16, when an input image from the image capturing device or the like is geometrically transformed and output into the image projecting devices 2a˜2d, cutting images are created from the input image at a cutting image creating section 51 so that the number of the cutting images are set equal to the number of the image projecting devices 2a˜2d. The cutting images are geometrically transformed and output at the geometrical transforming sections 9a˜9d corresponding to the image projecting devices 2a˜2d on the output geometrical profile stored in the output geometrical profile storing section 8 and the cutting image input geometrical profile stored in the cutting image input geometrical profile storing section 52.

The cutting image creating section 51 includes an input image storing section 53 to store a plurality of input images, a shading correcting section 54 to correct in shading the input images stored in the input image storing section 53, an image cutting section 55 to cut the image data covered by each image projecting device from the input image on the input geometrical profile which is stored in the input geometrical profile storing section 6 and the output geometrical profile which is stored in the output geometrical profile storing section 8 and to calculate the input geometrical profile of each cutting image to be stored in the cutting image input geometrical profile storing section 52, and a cutting image storing section 56 to store and output the cutting image corresponding to each image projecting device. The geometrical transforming sections 9a˜9d can have the same function as the geometrical transforming section 9 in the first embodiment.

Then, the process at the image cutting section 55 will be described with reference to the flowchart in FIG. 17. First of all, a plurality of input images stored in the input image storing section 53 are read in (Step S1), and the input geometrical profiles corresponding to the input images and the output geometrical profiles corresponding to the image projecting devices 2a˜2d (Step S2).

Then, the polar coordinate positions for some pixels at calculated boundary of each projected image is determined on the output geometrical profile read in, and the coordinate positions of an input image corresponding to the polar coordinate positions are determined on the input geometrical profile (Step S3).

Then, the coordinate positions of the input image for all of the pixels of the output image (within an area defined by the four corners or the four boundary lines) are calculated from the coordinate positions of the input image corresponding to the polar coordinate positions for some pixels at the four corners or the four boundary lines of each projected image by means of interpolating calculation (e.g., linear interpolating calculation), and each pixel value of the input image corresponding to the pixel position is extracted (Step S4) and stored as a cutting image data in the cutting image storing section 56(Step S6). Then, the polar coordinate system corresponding to the coordinate calculated by the interpolating calculation is calculated on the input geometrical profile and stored as a cutting image input profile in the cutting image input geometrical profile storing section 52 (Step S6).

If the Steps S3-S6 are repeated for all of the output images (projected images), the process at the image cutting section 55 will be finished.

At the Step S4, in the extraction of the image within the area defined by the four corners or the four boundary lines on the coordinate positions, an image within a larger area than the area predetermined by the four corners or the four boundary corners may be extracted by setting a margin for the coordinate positions and stored as the cutting image input profile. In this case, although the size of the cutting image becomes large to some degree, if the projecting area of each image projecting device may be changed with time after the cutting image is created (the cutting image input profile), the same cutting image (the same cutting image input profile) can be utilized again.

In this embodiment, since the cutting image creating section 51 is separated from the geometrical transforming sections 9a˜9d, only image data within a small viewing area covered by each image projecting device may be geometrically transformed at the corresponding geometrical transforming section, resulting in the reduction of the image calculation memory in comparison with the embodiments as previously described. In this embodiment, since the coordinate transformation is carried out only for some pixels at the four corners or the four boundary lines of each output image (projected image), the coordinate transformation can be simplified and the total structure of the image transforming device can be simplified, resulting in the reduction of the total cost of the device.

### Fifth Embodiment

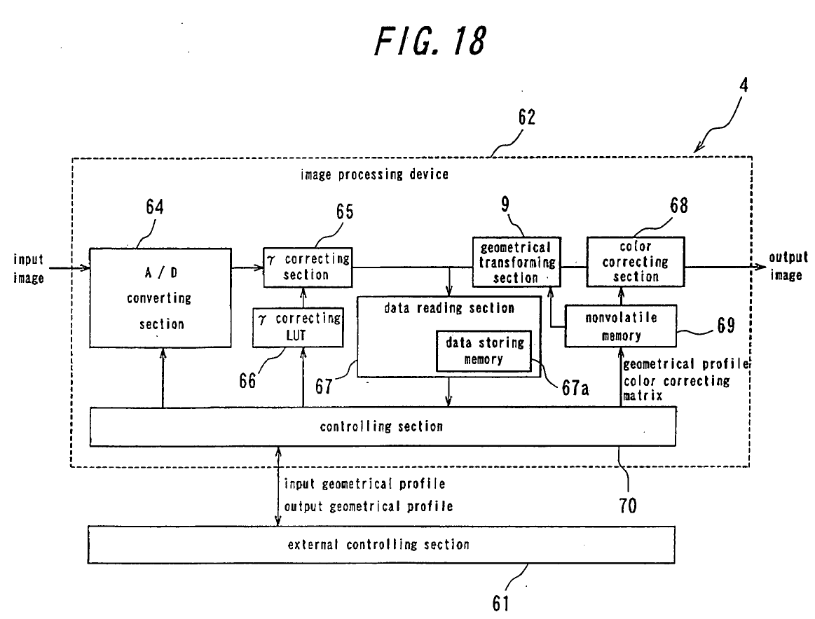

FIG. 18 is a structural view showing an essential part of a multiprojection system according to a fifth embodiment of the present invention. In this embodiment, the image transforming device 4 includes an external controlling device 61 and the image processing device 62 so that an input geometrical profile and output geometrical profile are calculated at the external controlling device 61 and supplied into the image processing device 62.

The image processing device 62 includes a data reading section 67 with an A/D transforming section 64, a γ correcting section 65, a γ correcting look-up table (LUT) 66 and a data storing memory 67a, the geometrical transforming section 9, a color correcting section 68, a nonvolatile memory 69 and controlling section 70. Into the γ correcting LUT 66 is stored a γ correcting data to correct the difference in tone characteristic (γ characteristic) between a plurality of input images and the pixels of the input images, and into the nonvolatile memory 69 are stored an input geometrical profile and an output geometrical profile from the external controlling device 61, and a color correcting matrix to correct the color shift in pixel of each image projecting device and the color shift between the image projecting devices to be used.

The input image is transformed into the digital image data through the A/D converting section 64, corrected in γ characteristic per pixel on the γ correcting data stored in the γ correcting LUT 66 and supplied into the geometrical transforming section 9. The γ correcting data can be calculated and stored in advance by the following steps. First of all, a given input image data is digitally transformed, read by the data reading section 67 via the γ correcting section 65 under through condition, and stored in the data storing memory 67a. The intended γ correcting data is calculated on the processed input image data by a conventionally known means, and stored in the γ correcting LUT 66.

At the geometrical transforming section 9, the input image is geometrically transformed on the input geometrical profile and the output geometrical profile which are stored in the nonvolatile memory 69 in the same manner as the above-described embodiment. The thus obtained image data is supplied into the color correcting section 68 wherein the RGB primary colors of the image data are corrected through the matrix transformation on a color correcting matrix stored in the nonvolatile memory 69.

In this way, in this embodiment, since the differences in tone (γ characteristic) between the input images and between the pixels of each input image are corrected at the γ correcting section 65 and the color shifts between the image projecting devices and the pixels of each image projecting device are corrected at the color correcting section 68, in addition to the corrections of the position shift of the image projecting device arrangement and the distortion of each image projecting device, a wide viewing range image can be displayed clearly on the screen by combining output (projected) images.

### Sixth Embodiment

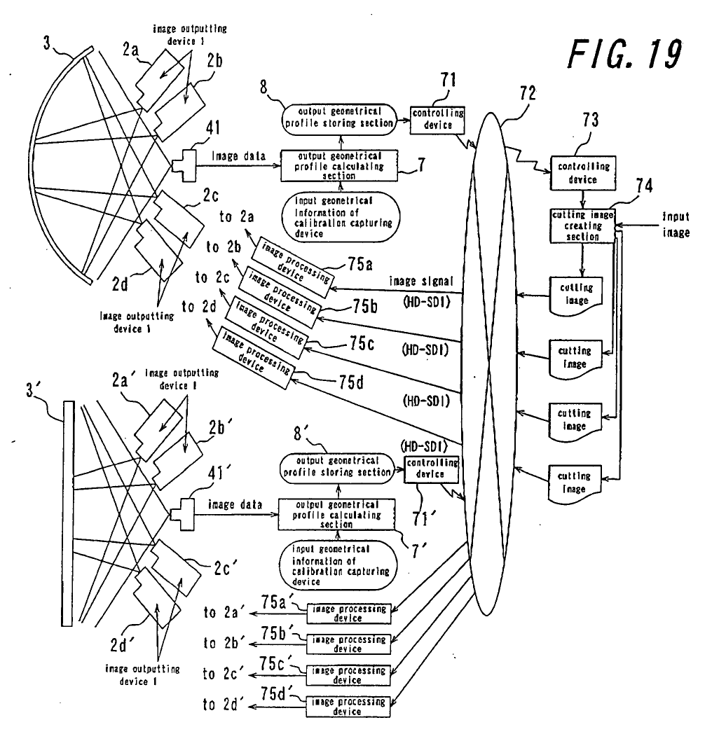

FIG. 19 is a structural view showing an essential part of a multiprojection system according to a sixth embodiment of the present invention. In this embodiment, the output geometrical profile calculated in the same manner as the third embodiment and stored in the output geometrical profile storing section 8 is transferred into the content supplying side via the network 72 from the controlling device 71 in the displaying system side. Moreover, the output geometrical profile in another displaying system side is also transferred into the content supplying side via the network 72. In FIG. 19, two types of displaying system are exemplified. One displaying system includes an arch-shaped screen 3 and the other displaying system includes a planer screen 3′. Like reference numbers designate like or corresponding parts throughout the displaying systems including the screens 3 and 3′.

In the content supplying side, the output geometrical profiles are received at the controlling device 73 from the displaying systems, and the input images are cut at the cutting image creating section 74 on the output geometrical profiles to create the cutting images so that the number of the cutting images are set equal to the number of the image projecting devices of the corresponding to the displaying system. The cutting images are transferred into the corresponding displaying systems via the network 72. The cutting image creating section 74 can have the same structure as the cutting image creating section 51 shown in FIG. 16.

In the displaying system, the cutting images which are transferred from the content supplying side are processed in image by means of geometrical transformation at the image processing devices 75a˜75d corresponding to the image projecting devices 2a˜2d, and displayed on the screen 3 by the image projecting devices 2a˜2d. The image processing devices 75a˜75d, 75a′˜75d′ can have the same structure as the image processing device 62 shown in FIG. 18.

In this embodiment, the content supplying side can transfer the cutting images commensurate with the screen shape of each displaying system into the corresponding displaying system via the network 72 only if the content supplying side receives the output geometrical profile from each displaying system via the network 72. Therefore, an image of wide viewing range, large size, high resolution and large capacity can be cut into high resolution digital television image signals (HD-SDI), etc., commensurate with the displaying system, and transferred commensurate with the transfer rate of an Internet communication or a broadband communication.

### Seventh Embodiment

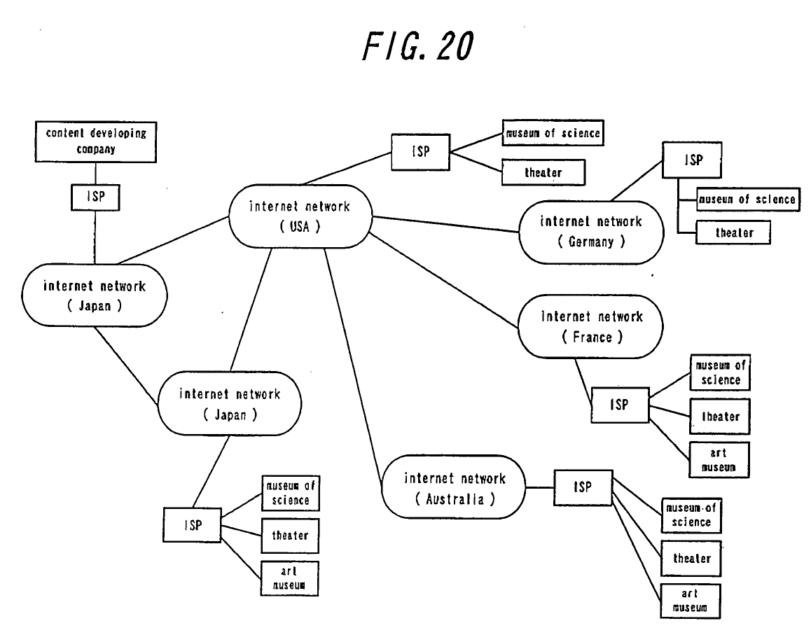

FIG. 20 is a structural view showing an essential part of a multiprojection system according to a seventh embodiment of the present invention. In this embodiment, a displaying system such as a dome-shaped displaying system, an arch-shaped displaying system or a video-wall displaying system, which is installed in a museum of science, a theater or an art museum all over the world, is connected to an Internet network via an Internet service provider (ISP), and the content supplying side which is installed in a content developing company is connected to the Internet network via the ISP so that a given image content developed in the company is delivered via the Internet network, thereby constituting a content world-wide supplying system. The content supplying side and the displaying system side can be configured such that the content supplying side receives the output geometrical profiles from the displaying systems and creates the cutting images commensurate with the screen shapes of the displaying systems, and the resultant cutting images are processed at the corresponding displaying systems and displayed in the same manner as the sixth embodiment.

For example, the image content can be centrally controlled and delivered by the content developing company. Moreover, the output geometrical profiles from the displaying systems can be centrally controlled so that a given image content with a destination tug may be delivered to the similar displaying systems successively. For example, the image content can be displayed at the displaying system and then, delivered to another displaying system similar to the previous displaying system. In this case, since the image content can be circulated automatically within the displaying systems with the similar structures to one another, the management cost can be reduced.

Although the present invention was described in detail with reference to the above examples, this invention is not limited to the above disclosure and every kind of variation and modification may be made without departing from the scope of the present invention. In the embodiments as described above, the number of the input image is set to three and the number of the output image, that is, the image projecting devices is set to four, the numbers of the input image and the output image may be set to any numbers.

1. An image transforming method comprising the steps of:
obtaining one input image or a plurality of input images captured or created under different condition, and
geometrically transforming said one input image or said plurality of input images to create an output image,
wherein said geometrical transformation is carried out on an input geometrical profile directing to a coordinate relation between pixel positions of said input image and polar coordinate positions of said input image in view of a given observing position and an output geometrical profile directing to a coordinate relation between pixel positions of said output image and polar coordinate positions of said output image in view of said observing position, thereby calculating said output image.

2. The image transforming method as defined in claim 1, wherein said input geometrical profile includes at least one selected from the group consisting of a two-dimensional look-up table to define a coordinate relation per pixel of said input image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein said output geometrical profile includes at least one selected from the group consisting of a two-dimensional look-up table to define a coordinate relation per pixel of said output image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein said geometrical transformation is carried out on at least one selected from a coordinate transformation using a table transformation with said two-dimensional look-up table, a projecting transformation using said projective transformation, a polar coordinate transformation using said polar coordinate transforming coefficient, a cylindrical transformation using said cylindrical coordinate transforming coefficient and a polynomial coordinate transformation using said polynomial transforming coefficient of said input geometrical profile and said output geometrical profile, thereby calculating said output image.

3. The image transforming method as defined in claim 1, further comprising the step of calculating an input-output geometrical profile directing to a coordinate relation between a coordinate position of said input image and a coordinate position of said output image from said input geometrical profile and said output geometrical profile,
wherein said geometrical transformation is carried out on said input-output geometrical profile, thereby calculating said output image.

4. The image transforming method as defined in claim 2, further comprising the step of calculating an input-output geometrical profile directing to a coordinate relation between a coordinate position of said input image and a coordinate position of said output image from said input geometrical profile and said output geometrical profile,
wherein said geometrical transformation is carried out on said input-output geometrical profile, thereby calculating said output image.

5. The image transforming method as defined in claim 1, further comprising the steps of:
obtaining coordinate positions of said input image corresponding to coordinate positions for pixels of said output image at calculated boundary of said output image on said input geometrical profile and said output geometrical profile, and
cutting images from said input image on said coordinate positions of said input image to create cutting images,
wherein said geometrical transformation is carried out for said cutting images, thereby calculating said output image.

6. The image transforming method as defined in claim 2, further comprising the steps of:
obtaining coordinate positions of said input image corresponding to coordinate positions for pixels of said output image at calculated boundary of said output image on said input geometrical profile and said output geometrical profile, and
cutting images from said input image on said coordinate positions of said input image to create cutting images,
wherein said geometrical transformation is carried out for said cutting images, thereby calculating said output image.

7. The image transforming method as defined in claim 3, further comprising the steps of:
obtaining coordinate positions of said input image corresponding to coordinate positions for pixels of said output image at calculated boundary of said output image on said input geometrical profile and said output geometrical profile, and
cutting images from said input image on said coordinate positions of said input image to create cutting images,
wherein said geometrical transformation is carried out for said cutting images, thereby calculating said output image.

8. The image transforming method as defined in claim 4, further comprising the steps of:
obtaining coordinate positions of said input image corresponding to coordinate positions for pixels of said output image at calculated boundary of said output image on said input geometrical profile and said output geometrical profile, and
cutting images from said input image on said coordinate positions of said input image to create cutting images,
wherein said geometrical transformation is carried out for said cutting images, thereby calculating said output image.

9. An image transforming device wherein one input image or a plurality of input images captured or created under different condition are geometrically transformed to create an output image, comprising:
an input geometrical profile calculating section to calculate an input geometrical profile directing to a coordinate relation between pixel positions of said input image and polar coordinate positions of said input image in view of a given observing position,
an output geometrical profile calculating section to calculate an output geometrical profile directing to a coordinate relation between pixel positions of said output image and polar coordinate positions of said output image in view of said observing position, and
geometrical transforming section to geometrically transform said input image on said input geometrical profile and said output geometrical profile, thereby calculating said output image.

10. The image transforming device as defined in claim 9, wherein said output geometrical profile calculates a plurality of output geometrically profiles for corresponding image output devices, and said geometrical transforming device calculates output images for said geometrical profiles, respectively.

11. The image transforming device as defined in claim 9, wherein said input geometrical profile calculating section calculates an input geometrical profile including at least one selected from the group consisting of a two-dimensional look-up table to define a coordinate relation per pixel of said input image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein said output geometrical profile calculating section calculates an output geometrical profile including at least one selected from the group consisting of a two-dimensional look-up table to define a coordinate relation per pixel of said output image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein said geometrical transforming section includes at least one selected from a coordinate transformation using a table transformation with said two-dimensional look-up table, a projecting transformation using said projective transformation, a polar coordinate transformation using said polar coordinate transforming coefficient, a cylindrical transformation using said cylindrical coordinate transforming coefficient and a polynomial coordinate transformation using said polynomial transforming coefficient of said input geometrical profile and said output geometrical profile.

12. The image transforming device as defined in claim 10, wherein said input geometrical profile calculating section calculates an input geometrical profile including at least one selected from the group consisting of a two-dimensional look-up table to define a coordinate relation per pixel of said input image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein said output geometrical profile calculating section calculates an output geometrical profile including at least one selected from the group consisting of a two-dimensional look-up table to define a coordinate relation per pixel of said output image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein said geometrical transforming section includes at least one selected from a coordinate transformation using a table transformation with said two-dimensional look-up table, a projecting transformation using said projective transformation, a polar coordinate transformation using said polar coordinate transforming coefficient, a cylindrical transformation using said cylindrical coordinate transforming coefficient and a polynomial coordinate transformation using said polynomial transforming coefficient of said input geometrical profile and said output geometrical profile.

13. The image transforming device as defined in claim 9, further comprising an input-output geometrical profile calculating section to calculate an input-output geometrical profile to define a coordinate relation between a coordinate position of said input image and a coordinate position of said output image on said input geometrical profile and said output geometrical profile,
wherein said input image is geometrically transformed on said input-output geometrical profile, thereby calculating said output image.

14. The image transforming device as defined in claim 10, further comprising an input-output geometrical profile calculating section to calculate an input-output geometrical profile to define a coordinate relation between a coordinate position of said input image and a coordinate position of said output image on said input geometrical profile and said output geometrical profile,
wherein said input image is geometrically transformed on said input-output geometrical profile, thereby calculating said output image.

15. The image transforming device as defined in claim 11, further comprising an input-output geometrical profile calculating section to calculate an input-output geometrical profile to define a coordinate relation between a coordinate position of said input image and a coordinate position of said output image on said input geometrical profile and said output geometrical profile,
wherein said input image is geometrically transformed on said input-output geometrical profile, thereby calculating said output image.

16. The image transforming device as defined in claim 12, further comprising an input-output geometrical profile calculating section to calculate an input-output geometrical profile to define a coordinate relation between a coordinate position of said input image and a coordinate position of said output image on said input geometrical profile and said output geometrical profile,
wherein said input image is geometrically transformed on said input-output geometrical profile, thereby calculating said output image.

17. The image transforming device as defined in claim 9, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

18. The image transforming device as defined in claim 10, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

19. The image transforming device as defined in claim 11, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

20. The image transforming device as defined in claim 12, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

21. The image transforming device as defined in claim 13, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

22. The image transforming device as defined in claim 14, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

23. The image transforming device as defined in claim 15, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

24. The image transforming device as defined in claim 16, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

25. A multiprojection system wherein one input image or a plurality of input images captured or created under different condition are geometrically transformed by an image transforming device to create a plurality of output images which are projected on a screen by corresponding image projecting devices and combined with one another to create a large-sized image,
wherein said image transforming device comprises:
an input geometrical profile calculating section to calculate an input geometrical profile directing to a˜coordinate relation between pixel positions of said input image and polar coordinate positions of said input image in view of a given observing position,
an output geometrical profile calculating section to calculate an output geometrical profile directing to a coordinate relation between pixel positions of said output image and polar coordinate positions of said output image in view of said observing position, and
geometrical transforming section to geometrically transform said input image on said input geometrical profile and said output geometrical profile, thereby calculating said output image.

26. The multiprojection system as defined in claim 25, wherein said input geometrical profile calculating section calculates an input geometrical profile including at least one selected from the group consisting of a two-dimensional look-up table to define a coordinate relation per pixel of said input image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein said output geometrical profile calculating section calculates an output geometrical profile including at least one selected from the group consisting of a two-dimensional look-up table to define a coordinate relation per pixel of said output image, a projective transformation to define a projection transforming coordinate relation from a plane coordinate into another plane coordinate, a polar coordinate transforming coefficient to define a polar coordinate transforming coordinate relation from a plane coordinate into a polar coordinate, a cylindrical coordinate transforming coefficient to define a cylindrical coordinate transforming coordinate relation from a plane coordinate into a cylindrical coordinate and a polynomial transforming coefficient to define coordinate transforming coordinate relation using two or more polynomial equations,
wherein said geometrical transforming section includes at least one selected from a coordinate transformation using a table transformation with said two-dimensional look-up table, a projecting transformation using said projective transformation, a polar coordinate transformation using said polar coordinate transforming coefficient, a cylindrical transformation using said cylindrical coordinate transforming coefficient and a polynomial coordinate transformation using said polynomial transforming coefficient of said input geometrical profile and said output geometrical profile.

27. The multiprojection system as defined in claim 25, further comprising an input-output geometrical profile calculating section to calculate an input-output geometrical profile to define a coordinate relation between a coordinate position of said input image and a coordinate position of said output image on said input geometrical profile and said output geometrical profile,
wherein said input image is geometrically transformed on said input-output geometrical profile, thereby calculating said output image.

28. The multiprojection system as defined in claim 26, further comprising an input-output geometrical profile calculating section to calculate an input-output geometrical profile to define a coordinate relation between a coordinate position of said input image and a coordinate position of said output image on said input geometrical profile and said output geometrical profile,
wherein said input image is geometrically transformed on said input-output geometrical profile, thereby calculating said output image.

29. The multiprojection system as defined in claim 25, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

30. The multiprojection system as defined in claim 26, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

31. The multiprojection system as defined in claim 27, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

32. The multiprojection system as defined in claim 28, further comprising an image cutting means to obtain coordinate positions of said input image corresponding to coordinate positions for pixels of said output image at calculated boundary of said output image on said input geometrical profile and said output geometrical profile and to cut images from said input image on said coordinate positions of said input image to create cutting images,
wherein said cutting images are geometrically transformed, thereby calculating said output image.

33. The multiprojection system as defined in claim 25, further comprising:
a test pattern image outputting means to provide test pattern images for said image projecting devices, and
a calibration image acquiring means to capture test pattern projecting images on said screen by said image projecting devices,
wherein said output geometrical profile calculating section calculates an output geometrical profile directing at a coordinate relation between coordinate positions of said test pattern projecting images acquired by said calibration image acquiring means and said polar coordinate positions of said output image in view of said observing position.

34. The multiprojection system as defined in claim 26, further comprising:
a test pattern image outputting means to provide test pattern images for said image projecting devices, and
a calibration image acquiring means to capture test pattern projecting images on said screen by said image projecting devices,
wherein said output geometrical profile calculating section calculates an output geometrical profile directing at a coordinate relation between coordinate positions of said test pattern projecting images acquired by said calibration image acquiring means and said polar coordinate positions of said output image in view of said observing position.

35. The multiprojection system as defined in claim 27, further comprising:
a test pattern image outputting means to provide test pattern images for said image projecting devices, and
a calibration image acquiring means to capture test pattern projecting images on said screen by said image projecting devices,
wherein said output geometrical profile calculating section calculates an output geometrical profile directing at a coordinate relation between coordinate positions of said test pattern projecting images acquired by said calibration image acquiring means and said polar coordinate positions of said output image in view of said observing position.

36. The multiprojection system as defined in claim 28, further comprising:
a test pattern image outputting means to provide test pattern images for said image projecting devices, and
a calibration image acquiring means to capture test pattern projecting images on said screen by said image projecting devices,
wherein said output geometrical profile calculating section calculates an output geometrical profile directing at a coordinate relation between coordinate positions of said test pattern projecting images acquired by said calibration image acquiring means and said polar coordinate positions of said output image in view of said observing position.

37. The multiprojection system as defined in claim 29, further comprising:
a test pattern image outputting means to provide test pattern images for said image projecting devices, and
a calibration image acquiring means to capture test pattern projecting images on said screen by said image projecting devices,
wherein said output geometrical profile calculating section calculates an output geometrical profile directing at a coordinate relation between coordinate positions of said test pattern projecting images acquired by said calibration image acquiring means and said polar coordinate positions of said output image in view of said observing position.

38. The multiprojection system as defined in claim 30, further comprising:
a test pattern image outputting means to provide test pattern images for said image projecting devices, and
a calibration image acquiring means to capture test pattern projecting images on said screen by said image projecting devices,
wherein said output geometrical profile calculating section calculates an output geometrical profile directing at a coordinate relation between coordinate positions of said test pattern projecting images acquired by said calibration image acquiring means and said polar coordinate positions of said output image in view of said observing position.

39. The multiprojection system as defined in claim 31, further comprising:
a test pattern image outputting means to provide test pattern images for said image projecting devices, and
a calibration image acquiring means to capture test pattern projecting images on said screen by said image projecting devices,
wherein said output geometrical profile calculating section calculates an output geometrical profile directing at a coordinate relation between coordinate positions of said test pattern projecting images acquired by said calibration image acquiring means and said polar coordinate positions of said output image in view of said observing position.

40. The multiprojection system as defined in claim 32, further comprising:
a test pattern image outputting means to provide test pattern images for said image projecting devices, and
a calibration image acquiring means to capture test pattern projecting images on said screen by said image projecting devices,
wherein said output geometrical profile calculating section calculates an output geometrical profile directing at a coordinate relation between coordinate positions of said test pattern projecting images acquired by said calibration image acquiring means and said polar coordinate positions of said output image in view of said observing position.

41. The multiprojection system as defined in claim 25, further comprising a geometrical profile combining means to combine and output or store said input image and said input geometrical profile or to combine and output or store an output image transformed by said image transforming device and said output geometrical profile.

42. The multiprojection system as defined in claim 26, further comprising a geometrical profile combining means to combine and output or store said input image and said input geometrical profile or to combine and output or store an output image transformed by said image transforming device and said output geometrical profile.

43. The multiprojection system as defined in claim 27, further comprising a geometrical profile combining means to combine and output or store said input image and said input geometrical profile or to combine and output or store an output image transformed by said image transforming device and said output geometrical profile.

44. The multiprojection system as defined in claim 28, further comprising a geometrical profile combining means to combine and output or store said input image and said input geometrical profile or to combine and output or store an output image transformed by said image transforming device and said output geometrical profile.

45. The multiprojection system as defined in claim 29, further comprising a geometrical profile combining means to combine and output or store said input image and said input geometrical profile or to combine and output or store an output image transformed by said image transforming device and said output geometrical profile.

46. The multiprojection system as defined in claim 30, further comprising a geometrical profile combining means to combine and output or store said input image and said input geometrical profile or to combine and output or store an output image transformed by said image transforming device and said output geometrical profile.

47. The multiprojection system as defined in claim 31, further comprising a geometrical profile combining means to combine and output or store said input image and said input geometrical profile or to combine and output or store an output image transformed by said image transforming device and said output geometrical profile.

48. The multiprojection system as defined in claim 32, further comprising a geometrical profile combining means to combine and output or store said input image and said input geometrical profile or to combine and output or store an output image transformed by said image transforming device and said output geometrical profile.

49. The multiprojection system as defined in claim 33, further comprising a geometrical profile combining means to combine and output or store said input image and said input geometrical profile or to combine and output or store an output image transformed by said image transforming device and said output geometrical profile.

50. The multiprojection system as defined in claim 34, further comprising a geometrical profile combining means to combine and output or store said input image and said input geometrical profile or to combine and output or store an output image transformed by said image transforming device and said output geometrical profile.

51. The multiprojection system as defined in claim 35, further comprising a geometrical profile combining means to combine and output or store said input image and said input geometrical profile or to combine and output or store an output image transformed by said image transforming device and said output geometrical profile.

52. The multiprojection system as defined in claim 36, further comprising a geometrical profile combining means to combine and output or store said input image and said input geometrical profile or to combine and output or store an output image transformed by said image transforming device and said output geometrical profile.

53. The multiprojection system as defined in claim 37, further comprising a geometrical profile combining means to combine and output or store said input image and said input geometrical profile or to combine and output or store an output image transformed by said image transforming device and said output geometrical profile.

54. The multiprojection system as defined in claim 38, further comprising a geometrical profile combining means to combine and output or store said input image and said input geometrical profile or to combine and output or store an output image transformed by said image transforming device and said output geometrical profile.

55. The multiprojection system as defined in claim 39, further comprising a geometrical profile combining means to combine and output or store said input image and said input geometrical profile or to combine and output or store an output image transformed by said image transforming device and said output geometrical profile.

56. The multiprojection system as defined in claim 40, further comprising a geometrical profile combining means to combine and output or store said input image and said input geometrical profile or to combine and output or store an output image transformed by said image transforming device and said output geometrical profile.
